(19) United States
(12) Patent Application Publication
(10) Pub. No.: US 2024/0390208 A1
(43) Pub. Date: Nov. 28, 2024

(54) LIMB POSITIONING DEVICE

(71) Applicant: Assured Innovations LLC, Hudson, OH (US)

(72) Inventor: Jonathan W. Klein, Hudson, OH (US)

(73) Assignee: Assured Innovations LLC, Hudson, OH (US)

(21) Appl. No.: 18/673,541

(22) Filed: May 24, 2024

Related U.S. Application Data
(60) Provisional application No. 63/469,165, filed on May 26, 2023.

(51) Int. Cl. A61G 13/12

(52) U.S. Cl. CPC A61G 13/1245

(57) ABSTRACT

A limb positioning device includes: a limb cradle having an upper limb cradle portion, a lower limb cradle portion, and a narrowed connecting strip extending between the upper limb cradle portion and the lower limb cradle portion to permit angulation of a limb joint (e.g., an elbow); and a support pad assembly including at least one support pad. The limb cradle and the support pad(s) may include foam.

This application claims the priority benefit of U.S. Provisional Application No. 63/469,165, filed May 26, 2023, and titled “LIMB POSITIONING DEVICE,” which is incorporated by reference in its entirety.

### BACKGROUND

Current patient positioning standards of the American Society of Anesthesiologists specify that “patient positioning and actions are taken to reduce the chance of adverse patient effects/complications related to positioning.” The current standard of practice for positioning the upper extremity states that the arm, if placed on an arm board in the operating room, should be less than ninety degrees from the body and placed in a supinated fashion. Despite proper, standard ASA positioning, brachial plexus injuries and lumbar strain still occur and can be severe enough to cause permanent injury or deficits.

The current products on the market that are used in the operating room only pad the arm at best. These devices still require the arm to be fully extended out, away from the body putting the patient in potential harm.

It would be desirable to develop new limb positioning devices.

### BRIEF DESCRIPTION

Disclosed, in some embodiments, is a limb positioning device including: a limb cradle having a first limb cradle portion, a second limb cradle portion, and a narrowed connecting strip extending between the first limb cradle portion and the second limb cradle portion to permit angulation of a limb joint; and a support pad assembly including at least one support pad and configured to be placed beneath the limb cradle.

The support pad assembly may include a first wedge-shaped support pad, a second wedge-shaped support pad; and a tearable support pad connection connecting the first wedge-shaped support pad to the second wedge-shaped support pad.

In some embodiments, the limb cradle and the support pad assembly contain a foam.

The first limb cradle portion may include a first limb receiving channel and a first pair of limb guides; and the second limb cradle portion may include a second limb receiving channel and a second pair of limb guides.

In some embodiments, the narrowed connecting strip does not include limb guides.

The second pair of limb guides may not extend to an edge of the second limb cradle portion opposite the narrowed connecting strip. In some embodiments, the edge is curved.

The support pad assembly may include a narrowed portion configured to be located beneath the narrowed connecting strip of the limb cradle.

In some embodiments, the first limb cradle portion is located at a higher elevation than the second limb cradle portion.

The limb cradle and the support pad assembly may contain a polyurethane foam and/or a polyethylene foam.

The limb cradle and/or the support pad assembly may contain an open-cell foam.

In some embodiments, wherein the limb cradle and/or the support pad assembly contain a closed-cell foam.

The limb cradle may contain a foam containing an antimicrobial additive (e.g., copper, silver, zinc).

Disclosed, in other embodiments, is a limb positioning device having a foam limb cradle and a support pad assembly. The foam limb cradle includes a first limb cradle portion having: a first pair of limb guides and a first limb receiving channel extending between the first pair of limb guides; a second limb cradle portion having: a second pair of limb guides; and a second limb cradle portion extending between the second pair of limb guides; and a narrowed connecting strip extending between the first limb cradle portion and the second limb cradle portion to permit angulation of a limb joint. The narrowed connecting strip does not include limb guides. The support pad assembly includes at least two foam support pads configured to be placed beneath the limb cradle. The support pad assembly includes a narrow portion to permit angulation of the limb joint. The second pair of limb guides do not extend to a curved edge of the second limb cradle portion opposite the narrowed connecting strip.

The support pad assembly may further include: a tearable connecting strip connecting the two foam support pads.

In some embodiments, the limb cradle and/or the support pad assembly independently contain a polyurethane foam and/or a polyethylene foam.

The foam may be an open-cell foam or a closed cell foam.

Disclosed, in further embodiments, are limb positioning devices including: a limb cradle having an upper limb cradle portion, a lower limb cradle portion, and a narrowed connecting strip extending between the upper limb cradle portion and the lower limb cradle portion to permit angulation of a limb joint; at least one upper limb pad configured to be detachably associated with the upper limb cradle portion; and at least one lower limb pad configured to be detachably associated with the lower limb cradle portion.

The at least one upper limb pad may include two upper limb pads and/or the at least one lower limb pad include two lower limb pads.

In some embodiments, the pads are wedge-shaped.

The pads may be detachably associated with the limb cradle via hook and loop fasteners.

In some embodiments, the upper limb cradle portion is configured to receive an upper arm and the lower limb cradle portion is configured to receive a lower arm.

The upper limb cradle portion may be configured to receive a calf and the lower limb cradle portion may be configured to support a heel.

In some embodiments, a gap is present beneath the narrowed connecting strip between the at least one upper limb pad and the at least one lower limb pad.

One or more of the components may be made from foam. The various foam components may be formed from the same foam. However, in some embodiments, the foam limb cradle is formed from a different foam compared to at least one of the foam pads.

In some embodiments, the at least one upper limb foam pad and the at least one lower limb pad are tearable.

The least one upper limb pad and/or the at least one lower limb pad may include perforations to enable more precise tearing to achieve at least one of a desired angle, a desired shape, and a desired thickness.

The limb positioning device may further include at least one strap configured to secure a limb to the limb cradle.

Disclosed, in further embodiments, are arm positioning devices for a supine patient. The devices include an arm cradle having an upper arm cradle portion, a lower arm cradle portion, and a narrowed connecting strip extending between the upper arm cradle portion and the lower arm cradle portion to permit angulation of a limb joint; at least one upper arm pad configured to be detachably associated with the upper limb cradle; and at least one lower arm pad configured to be detachably associated with the lower limb cradle.

The arm cradle may be angled upward from the upper arm cradle portion to the lower arm cradle portion.

Disclosed, in further embodiments, are arm positioning devices for a prone patient. The devices include an arm cradle having an upper arm cradle portion, a lower arm cradle portion, and a narrowed connecting strip extending between the upper arm cradle portion and the lower arm cradle portion to permit angulation of a limb joint; at least one upper arm pads configured to be detachably associated with the upper limb cradle portion; and at least one lower arm pad configured to be detachably associated with the lower limb cradle portion.

The arm cradle may be angled downward from the upper arm cradle portion to the lower arm cradle portion.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a side view of a limb positioning device in accordance with some embodiments of the present disclosure.

FIG. 2 is a side view of another limb positioning device in accordance with some embodiments of the present disclosure.

FIG. 3 is a perspective view of another limb positioning device in accordance with some embodiments of the present disclosure.

FIG. 4 is a side view of the limb positioning device of FIG. 3.

FIG. 5 is a front view of the limb positioning device of FIG. 3.

FIG. 6 is a rear view of the limb positioning device of FIG. 3

FIG. 7 is a top view of the limb positioning device of FIG. 3

FIG. 8 is a bottom view of the limb positioning device of FIG. 3.

FIG. 9 is a perspective view of a limb cradle of the limb positioning device of FIG. 3.

FIG. 10 is a side view of a support pad assembly of the limb positioning device of FIG. 3.

FIG. 11 is a zoomed in view of the support pad assembly of FIG. 10, emphasizing a support pad connection thereof.

FIG. 12 shows a limb positioning device for the left arm of a first person in a supine position.

FIG. 13 shows two limb positioning devices for both arms in the supine position.

FIG. 14 shows the same position from a different angle.

FIG. 15 shows the limb cradle in use with the left elbow bent and arm extending across the body in a supine position.

FIG. 16 shows the support pad in use for a supine position with the right arm at the side of the body.

FIG. 17 shows the support pad supporting a leg in a supine position.

FIG. 18 shows the prone volunteer using a limb positioning device with the arm extending outward and the elbow bent such that the hand is extending upward.

FIG. 19 shows a different angle of the same position.

FIG. 20 shows the volunteer using the support pad as a leg support in a prone position.

FIG. 21 shows a second person in a supine position with a limb positioning device supporting his left arm.

FIG. 22 shows the support pad being used to support the arm at the side in a supine position.

FIG. 23 shows the support pad being used to support a left leg in a supine position.

FIG. 24 shows the limb cradle in use with the left elbow bent and arm extending across the body in a supine position and a second limb positioning device supporting the right arm.

FIG. 25 shows the prone volunteer using a limb positioning device with the arm extending outward and the elbow bent such that the hand is extending upward.

FIG. 26 is a side view of a non-limiting example of a limb cradle with dimensions in inches.

FIG. 27 is a bottom view of the limb cradle of FIG. 26.

FIG. 28 is a front view of a portion of the limb cradle of FIG. 26.

FIG. 29 is a side view of a side view of a non-limiting example of a support pad assembly with dimensions in inches.

FIG. 30 is a top view of the support pad assembly of FIG. 29.

FIG. 31 is a rear view of the support pad assembly of FIG. 29.

### DETAILED DESCRIPTION

The present disclosure may be understood more readily by reference to the following detailed description of desired embodiments included therein. In the following specification and the claims which follow, reference will be made to a number of terms which shall be defined to have the following meanings.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent can be used in practice or testing of the present disclosure. All publications, patent applications, patents, and other references mentioned herein are incorporated by reference in their entirety. The materials, methods, and articles disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases that require the presence of the named ingredients/steps and permit the presence of other ingredients/steps. However, such description should be construed as also describing compositions, mixtures, or processes as “consisting of” and “consisting essentially of” the enumerated ingredients/steps, which allows the presence of only the named ingredients/steps, along with any impurities that might result therefrom, and excludes other ingredients/steps.

The present disclosure relates to a limb positioning device (e.g., a foam limb positioning device) that not only protects a patient's extremity from potential injury but is adjustable to conform to each individual patient. Although the device may be described as a foam device, it should be understood that the use of non-foam materials is also disclosed. Moreover, when the device is a foam device, all or only a portion of the components of the device may be formed from foam. Other materials providing similar padding/comfort and form recovery characteristics may be utilized in addition or as an alternative to foam. Additionally, in some embodiments, only the limb cradle possesses these characteristics, and the underlying components may be made from a more rigid material.

The device may be useful for positioning an arm or a leg. The patient may use the device in a supine or a prone position.

The device is multi-tiered and may gradually elevate an upper extremity (i.e., an arm) decreasing the strain on the brachial plexus. Alternatively, the device may be placed under a lower extremity (i.e., a leg), taking strain off the patient's lumbar region.

The device conforms to each patient and includes a plurality of layers. These layers may be easily added or removed based on the patient's body habitus to optimize patient position and safety.

This device alleviates pressure and tension from neurovascular bundles and complexes within or near the treated extremity. This alleviation of pressure in the extremities is accomplished by reducing any stretch or strain on the brachial plexus or lumbar region. This device may be used in an operating room, an intensive care unit, at rehabilitation centers, or for personal use depending on the circumstances.

In some embodiments, the device is used to elevate an extremity to decrease any swelling and/or fluid retention.

The device includes an upper limb region and a lower limb region. The upper and lower limb regions are connected via a bridging strip which is narrowed at the center to allow for angulation. This narrowed foam section may also be a place of separation between the two sections to allow for greater patient conformity.

In some embodiments, each of the upper and lower limb regions includes at least one (e.g., at least two) angulated foam pads beneath a unitary extremity cradle. The multi-tiered sections or foam pads may be connected to each other and to the extremity cradle via hook and loop fasteners. In some embodiments, the foam pads may be initially attached to each other by a small connecting strip of foam, enabling the user to easily rip and separate the layers and reconfigure them as desired. The small connecting strip of foam may or may not be perforated. The foam layers may be easily separated by pulling against one of the foam layers ripping that small connecting strip adjusting the device to conform to the patient's needs. By reconfiguring or removing various foam layers (or portions of foam layers) of the device, it provides multiple configurations to help optimize and safely position the patient.

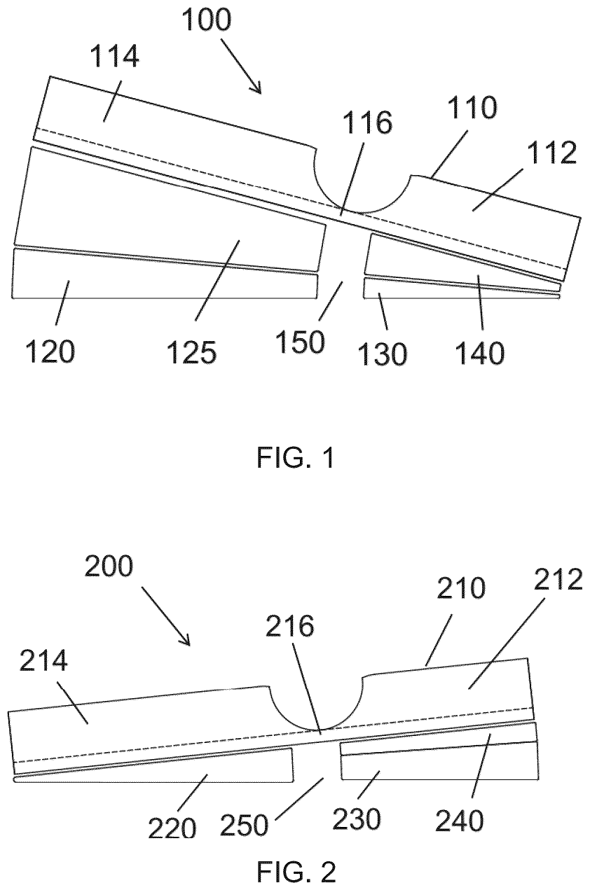

FIG. 1 is a side view of a limb positioning device (e.g., an arm positioning device for a supine patient) 100 in accordance with some embodiments of the present disclosure. The device 100 includes a foam limb cradle 110 including an upper limb cradle portion 112, a lower limb cradle portion 114, and a narrowed strip 116 connecting the upper limb cradle portion to the lower limb cradle portion. A first upper limb foam pad 130 and a second upper limb foam pad 140 are provided beneath the upper limb cradle portion of the foam limb cradle 110. A first lower limb foam pad 120 and a second lower limb foam pad 125 are provided beneath the lower limb cradle portion of the foam limb cradle 110. A gap 150 may be present between the lower limb foam pads 120, 125 and the upper limb foam pads 130, 140.

In some embodiments, the foam limb cradle 110 and foam pads 120, 125, 130, 140 are made of the same foam material. In other embodiments, the foam limb cradle 110 is made from a different foam material.

FIG. 2 is a side view of a limb positioning device (e.g., an arm positioning device for a prone patient) 200 in accordance with some embodiments of the present disclosure. The device 200 includes a foam limb cradle 210 including an upper limb cradle portion 212, a lower limb cradle portion 214, and a narrowed strip 216 connecting the upper limb cradle portion to the lower limb cradle portion. A first upper limb foam pad 230 and a second upper limb foam pad 240 are provided beneath the upper lib cradle portion of the foam limb cradle 210. A first lower limb foam pad 220 is provided beneath the lower limb cradle portion of the foam limb cradle 210. A gap 250 may be present between the lower limb foam pad 220 and the upper limb foam pads 230, 240.

In some embodiments, the foam limb cradle and foam pads are made of the same foam material. In other embodiments, the foam limb cradle is made from a different foam material. In some embodiments, the underlying pads are made from a more rigid foam material than the cradle. It is also contemplated that the underlying pads are formed from other, non-foam materials. The non-foam materials may be rigid.

The limb cradle may be soft and durable and may evenly pad the limb, reducing any pressure on the tissue while providing support to place the patient's limb in a position of comfort and safety. The underlying support layer(s) may be made of foam of a reusable material, providing supportive structure as well as enhancing comfort and safety.

The foam or the foam limb cradle and/or the foam pads may be an open-cell foam.

In some embodiments, the foam is a polyurethane foam (e.g., an open-cell polyurethane foam). The polyurethane may be an ester polyurethane or an ether polyurethane.

In some embodiments, the foam is a polyethylene foam (e.g., a closed-cell polyethylene foam).

Other non-limiting examples of foam materials include polypropylene, polystyrene, polyamide (e.g., Nylon), and silicone.

The foam may include one or more additives. Non-limiting examples of suitable additives include colorants and antimicrobial agents. The antimicrobial agent may comprise a metal. In non-limiting embodiments, the metal is copper, silver, or zinc (e.g., a copper, silver, or zinc compound).

The foam may have a density in a range of from about 0.5 to about 6 pounds per cubic foot.

The number of pores per inch may be in a range of from about 5 to about 150.

The cell size diameter may be in a range of from about 50 to about 200 μm (e.g., about 100 μm).

The foam may have an indentation force deflection (IFD) measured according to ASTM D3574 B1 in a range of from about 5 to about 150.

The foam may be cut from a block, thermally-shaped in a mold, shaped from a plastic resin, or formed from an additive manufacturing (e.g., 3D printing) process.

At least the foam limb cradle may be formed from a medical grade foam.

In particular embodiments, the foam includes DermaProx™ foam.

In some embodiments, the pads include a cover injected with non-woven fibers. Non-limiting examples of fibers include carbon fibers, aramid fibers, and polyester fibers.

One or more straps may be utilized to secure the patient's limb to the device. For example, a strap may be included around at least a top portion of the foam limb cradle at the upper limb portion, at the lower limb portion, and/or at the connecting strip.

As alternatives or in addition to straps, medical tape and/or a suitable adhesive may be utilized.

The various foam components may be secured together using one or more fasteners. Non-limiting examples of suitable fasteners include hook and loop fasteners, tapes, and adhesive compositions. The fastener(s) may be located on the entirety of one or more surfaces to be joined or on only a portion thereof. The fasteners may be selectably detachable.

It is also contemplated that the fasteners may be located at one or more perimeter regions of the surfaces to be detachably connected.

Moreover, it is contemplated that hook elements and/or loop elements may extend in a strip extending an entire length (or close to an entire length) of the surfaces to be joined. This may allow for additional flexibility by sliding one element relative to another along the length to arrive at a desired shape, length, and/or angle.

The size of the recess for receiving the limb may be the same in both the upper and lower limb regions. In other embodiments, the recess sizes are different. For example, the recess in the upper limb region may be of a greater size (e.g., diameter) than the recess in the lower limb region. The entire size of the device may vary in length and width to accommodate patients and limbs of every needed size (e.g., from neonates to obese adults).

The various foam components may be formed in their desired shapes. Alternatively, the foam may be provided in blocks and cut to the desired shapes.

Although in FIGS. 1 and 2 the number of foam pads in the upper and lower limb regions is one or two, it is also contemplated that additional foam pads may be used for increased flexibility and/or more rapidly configuring the device into a desired shape. For example, when a larger number of relatively smaller foam pads are used, desired thickness and/or angle may be quickly adjusted by removing existing or adding new foam pads in the upper limb region and/or the lower limb region.

Each of the upper and lower limb regions may independently be associated with one, two, three, four, five, six, seven, eight, nine, ten, or more underlying foam pads. The tearing feature is optional, and the device may initially be configured with a number and size of layers suitable for most patient positioning needs. By tearing away and reconfiguring the layers, the device can be configured for additional patient positioning needs.

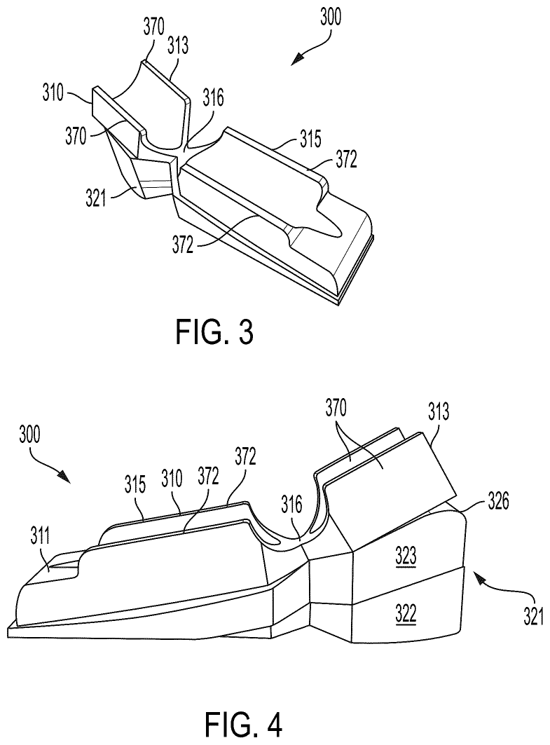

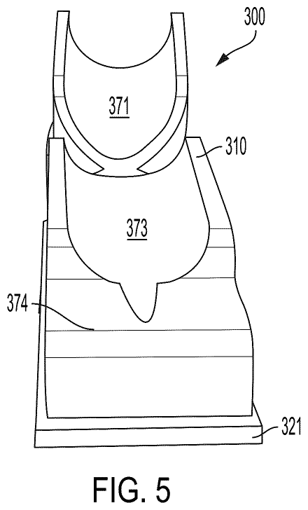

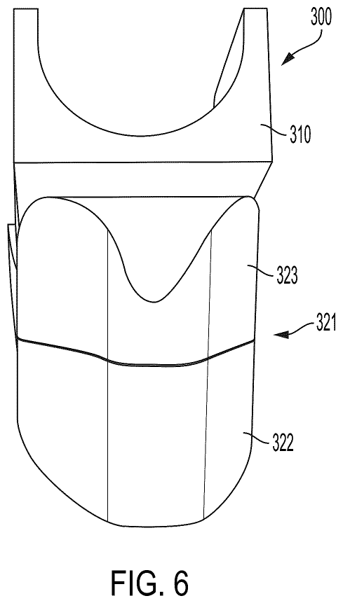

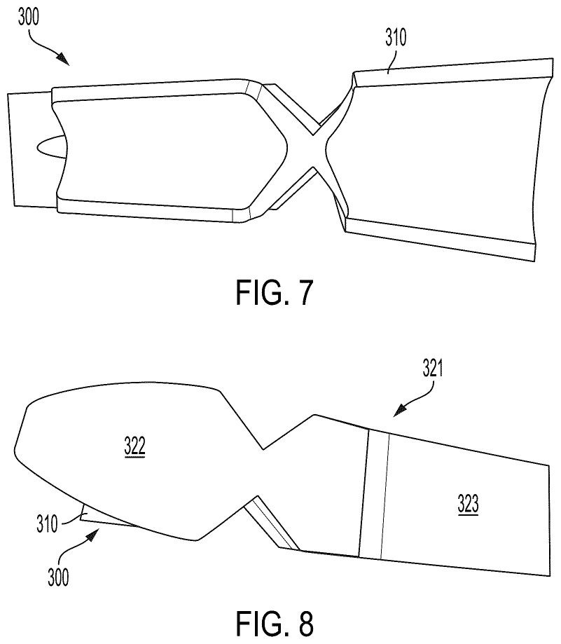

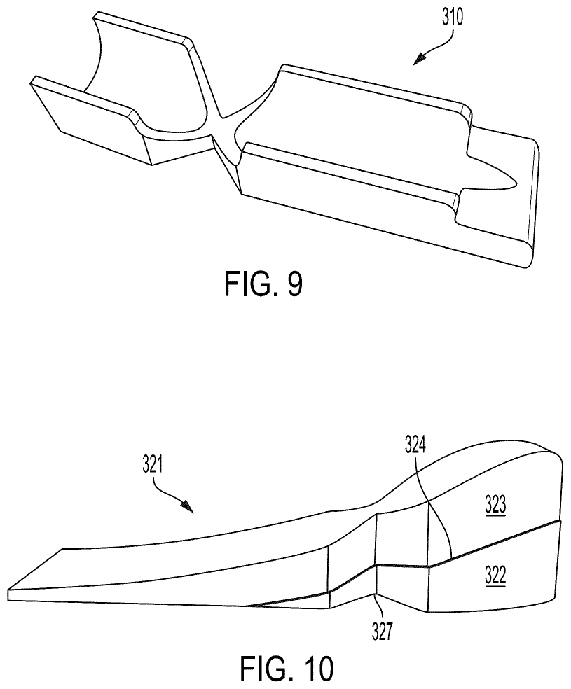

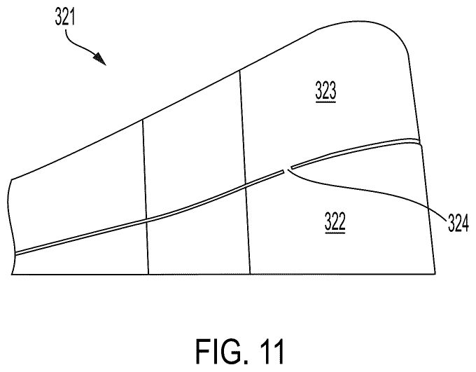

FIGS. 3-11 illustrate various aspects of another limb positioning device 300 in accordance with some embodiments of the present disclosure. It should be understood that features from FIGS. 1 and/or 2 may be utilized in the device of FIG. 3 and vice versa. FIG. 3 is a perspective view, FIG. 4 is a side view, FIG. 5 is a front view, FIG. 6 is a rear view, FIG. 7 is a top view, and FIG. 8 is a bottom view of the limb positioning device. FIG. 9 is a perspective view of a limb cradle 310 of the device. FIG. 10 is a side view of a support pad assembly 321 of the device and FIG. 11 is a zoomed in view of the support pad assembly, emphasizing a support pad connection thereof.

The device 300 includes a limb cradle 310 and a support pad assembly 321. The limb cradle 310 includes a first limb cradle portion 313, a second limb cradle portion 315, and a narrow strip 316 extending therebetween. The narrow strip 316 may be configured to receive a joint (e.g., a hinge joint such as an elbow) of a patient to permit angulation. The narrow strip 316 may exhibit a reduced width and/or height relative to the limb receiving channel in the first limb cradle portion 313 and/or the second limb cradle portion 315.

The first limb cradle portion 313 includes a first limb cradle channel 371 for receiving a first limb portion of a patient and extending between first limb portion guide elements 370.

The second limb cradle portion 315 includes a second limb cradle channel 373 for receiving a second limb portion of a patient and extending between second limb portion guide elements 372. The end 374 of the second limb cradle portion 315 opposite the narrow strip 316 may not include the guide elements. This may permit the patient to more comfortably spread the hand, fingers, etc. in embodiments wherein the limb is an arm. In some embodiments, the end 374 is curved. This curvature may allow the patient's hand and digits to be optimally supported, maintain a neutral position, and allow direct visualization to a medical provider. The open end 374 may further facilitate treatment (e.g., by making the hand/wrist area more easily accessible for administration of medicines or fluids via an intravenous tube and/or for drawing blood). The lack of guide elements at the open end may allow the patient's thumb to be placed in that area, thereby optimizing protection for the patient's hand and/or maintaining neutrality.

The narrow strip 316 does not include guide elements. The lack of guide elements may facilitate angulation and improve access for treatment (e.g., by making the elbow area more easily accessible for administration of medicines or fluids via an intravenous tube and/or for drawing blood).

The cradle may treat the limb as having a conical shape instead of a cylindrical shape and may have a gradual vertical include from the beginning of the cradle to the end where the hand would be positioned. Such angulation may allow for direct contact throughout the entire arm.

The support pad assembly 321 includes a lower support pad 322 and an upper support pad 323. The upper support pad 322 and the lower support pad 323 may be connected via a support pad connection 324 to define a unitary structure. It should be understood that more than one support pad connection 324 may be included and any support pad connection may be configured to be located on either side of the narrow strip 316 of the limb cradle 310 or directly below the narrow strip 316. The support pad connection 324 may be relatively thin to permit easy tearing and thus separation. Optionally, the connection 324 includes perforations to facilitate tearing. Support pads of the support pad assembly may also be detachably secured together via one or more fasteners (e.g., hook and loop fasteners). Although the depicted support pad assembly 321 includes two support pads, it should be understood that other numbers of support pads may be utilized. For example, a single support pad could be used for simplicity. Alternatively, three, four, five, six, seven, eight, nine, ten, or more may be utilized to permit rapid adjustment of the angle of elevation or height at distal and/or proximal locations of the limb. The uppermost pad of the support pad assembly 321 may include a curved edge 326. The curved edge of the support pad may allow for optimal positioning in a patient's axilla or underneath the knee. The pad can be positioned in the axilla for prone positioning. The pad can be positioned under the knee for supine positioning while trying to elevate the legs and take the strain off the lumbar region. The support pad configuration can be altered to place the two limb cradle portions at different elevations with respect to each other. By reversing the directions of the support pads, the first limb cradle portion could be higher or lower than the second limb cradle portion to cater to different patient positions.

It is also contemplated that the cradle may be connected to the support pad assembly via one or more connections similar to the support pad connection. Alternatively, or in addition thereto, one or more fasteners (e.g., hook and loop fasteners) may be used to secure the cradle and assembly together.

Similar to the narrowed connecting strip of the limb cradle 310, the support pad assembly 321 may include a narrowed portion 327 configured to be associated with the narrowed connecting strip of the limb cradle. Such narrowing may be present in one, more than one, or all of the support pads. The narrowing here may again enable angulation of a joint of a patient. However, the narrow portions of the support pads need not align with the narrow portion of the limb cradle, particularly when the limb does not need to angulate (e.g., for a supine patient with arms straight out).

The term “narrowed” in the context of the narrowed connecting strip 316 of the limb cradle 310 and the narrowed portion 327 in the support pad assembly 321 refers to a reduction in width (defined by the vertical direction in FIG. 7). The narrowing may be gradual and linear or curved.

Although the depicted foam pads are wedge-shaped, other shapes are also contemplated. For example, foam blocks that are rectangular prisms when no forces are applied are contemplated. In some embodiments, these rectangular prism foam blocks may be the lowermost elements in foam pad stacks and may be quickly swapped in or out to achieve a desired elevation.

For additional flexibility, the foam pads and/or the foam cradle may be adjusted in size (e.g., by tearing or cutting). The torn surface(s) may be planar or substantially planar. However, this is not required. The pads and/or cradle may be formed from a compressible material so that uneven portions can compress easily without impairing overall device function. One or more sets of perforations may be included to facilitate rapid cutting or tearing. Additionally, indications concerning distances and/or angles may be printed or otherwise provided on the foam pads. In some embodiments, each such indication is associated with a different perforation to enable rapid and precise resizing.

One, two, three, or four limb positioning devices may be used simultaneously. In some embodiments, two arm positioning devices are used simultaneously. In some embodiments, two leg positioning devices are used simultaneously. In some embodiments, two arm positioning devices and two leg positioning devices are used simultaneously (e.g., during surgery).

The following examples are provided to illustrate the devices and methods of the present disclosure. The examples are merely illustrative and are not intended to limit the disclosure to the materials, conditions, or process parameters set forth therein.

### EXAMPLES

The limb positioning devices of the present disclosure may be used to support many different anatomical regions in many different positions.

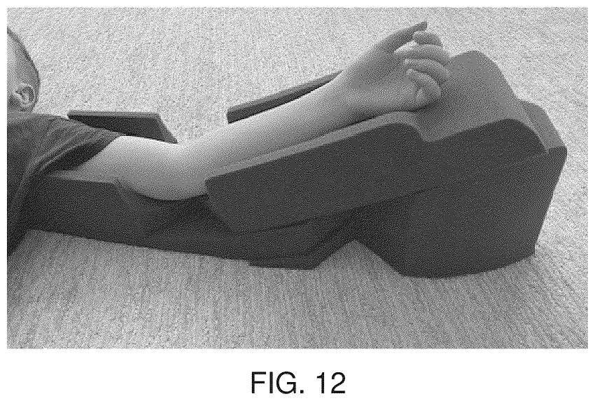

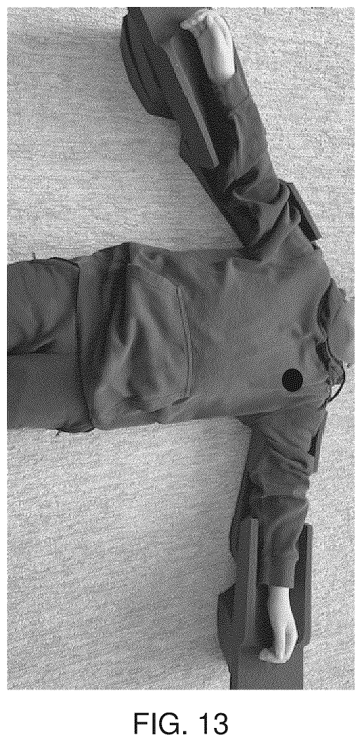

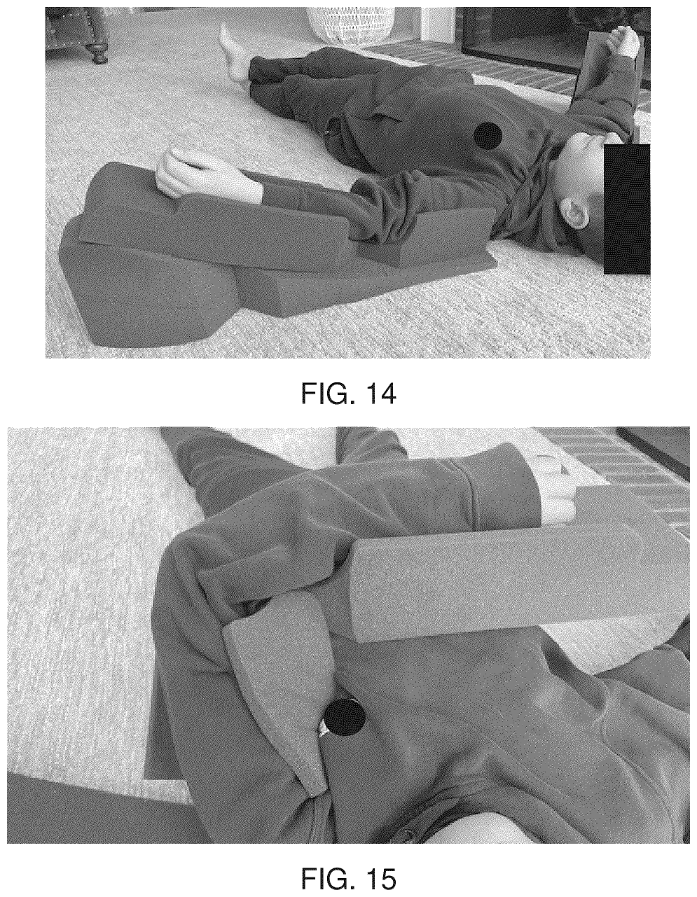

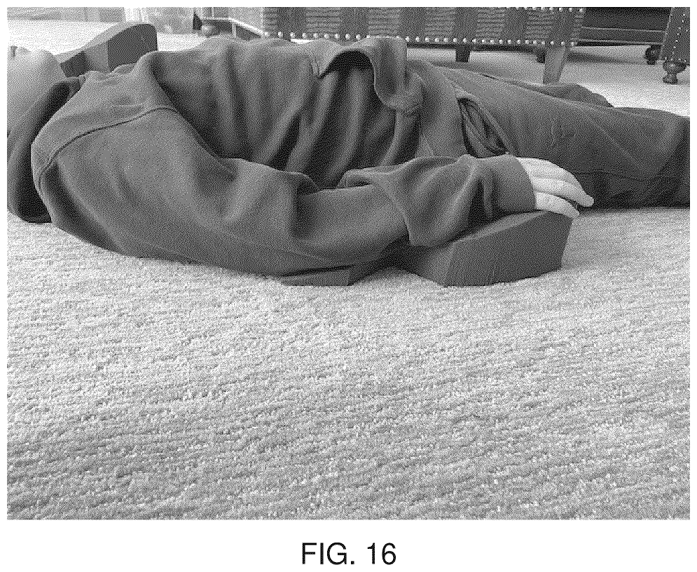

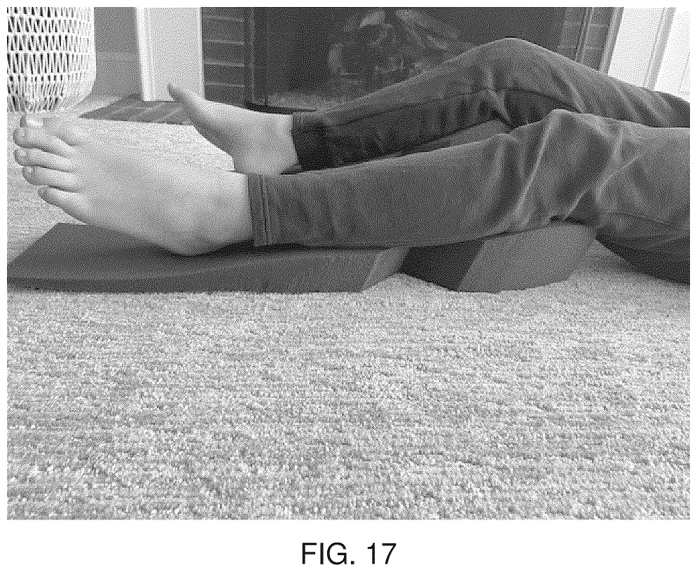

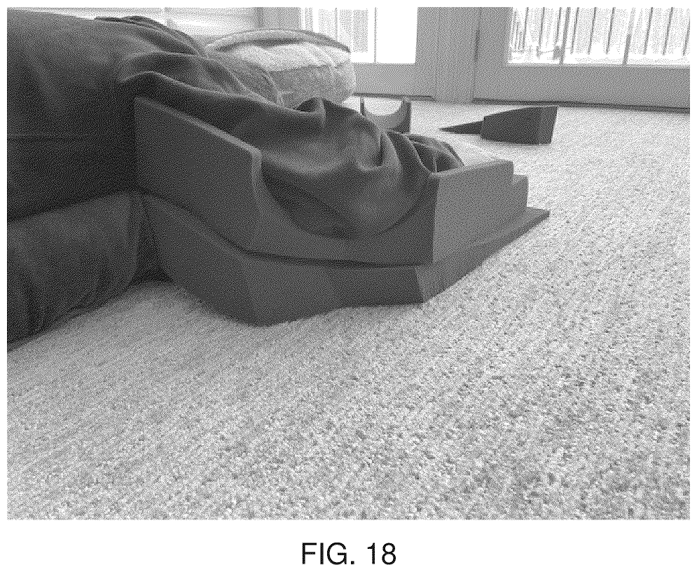

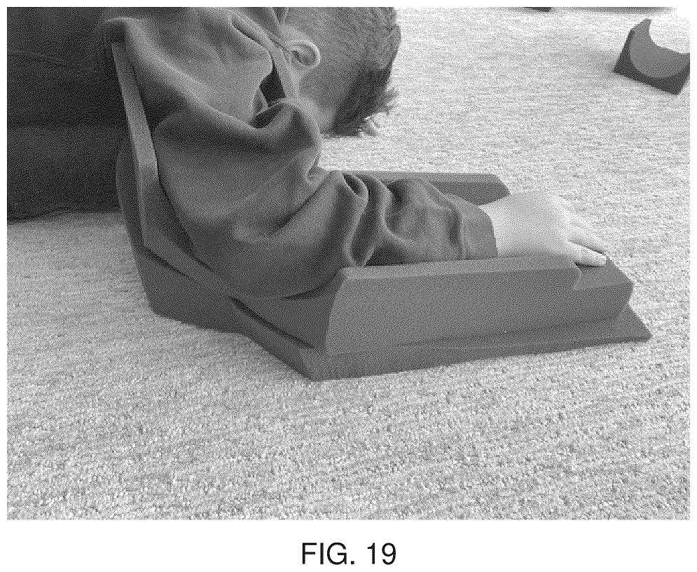

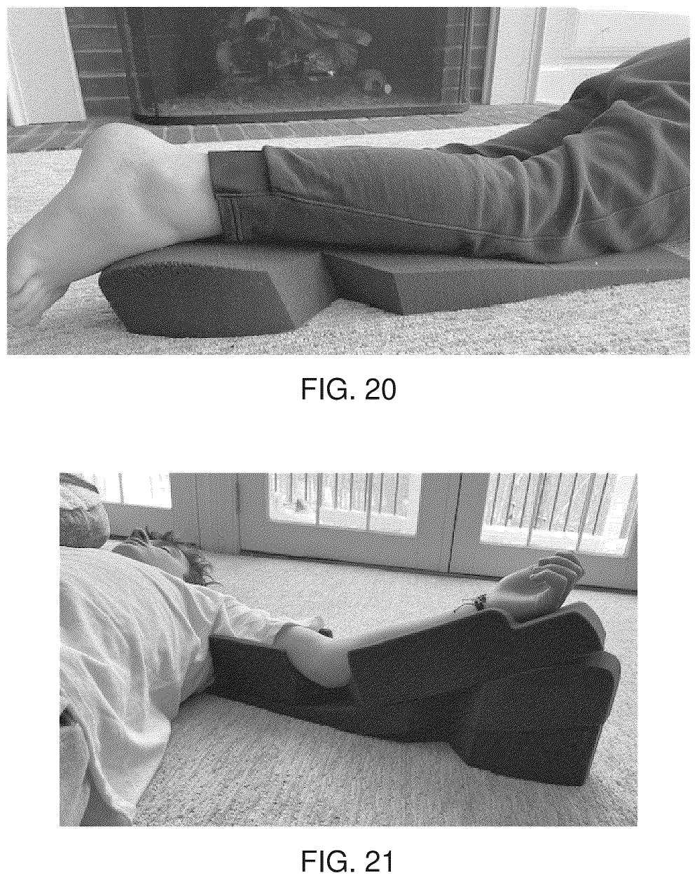

FIGS. 12-25 are photographs illustrating volunteer test subjects in various positions. FIG. 12 shows a limb positioning device for the left arm of a first person in a supine position. FIG. 13 shows two limb positioning devices for both arms in the supine position. FIG. 14 shows the same position from a different angle. FIG. 15 shows the limb cradle in use with the left elbow bent and arm extending across the body in a supine position. FIG. 16 shows the support pad in use for a supine position with the right arm at the side of the body. FIG. 17 shows the support pad supporting a leg in a supine position. FIG. 18 shows the prone volunteer using a limb positioning device with the arm extending outward and the elbow bent such that the hand is extending upward. FIG. 19 shows a different angle of the same position. FIG. 20 shows the volunteer using the support pad as a leg support in a prone position.

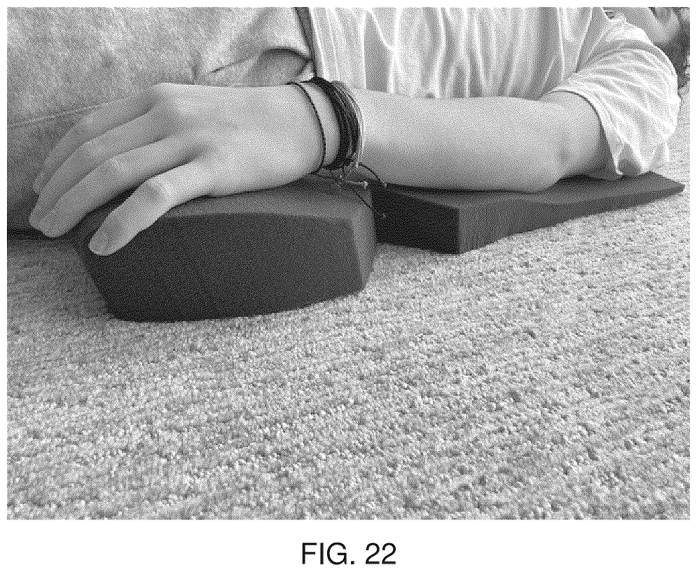

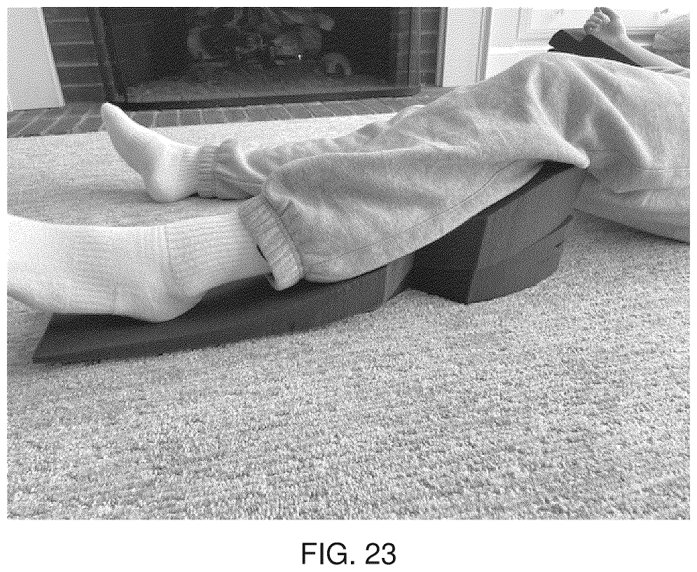

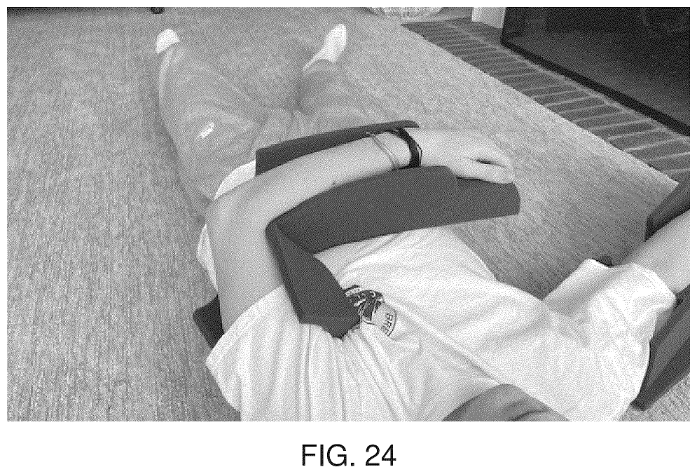

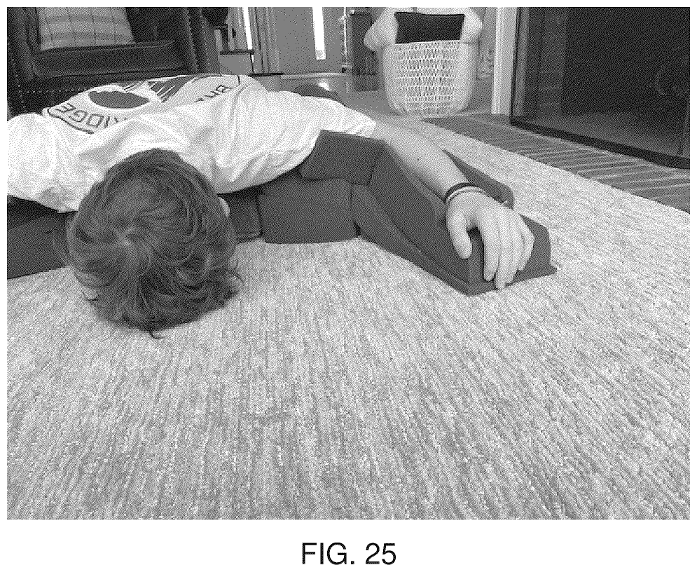

FIG. 21 shows a second person in a supine position with a limb positioning device supporting his left arm. FIG. 22 shows the support pad being used to support the arm at the side in a supine position. FIG. 23 shows the support pad being used to support a left leg in a supine position. FIG. 24 shows the limb cradle in use with the left elbow bent and arm extending across the body in a supine position and a second limb positioning device supporting the right arm. FIG. 25 shows the prone volunteer using a limb positioning device with the arm extending outward and the elbow bent such that the hand is extending upward.

In the supine position, the arms can be extended or tucked at the side. The base may be utilized for support of the tucked arm or hand when placed at the patient's side. The arm cradle and the base could both be used for this application.

The base can also be used to support the patient's lower extremity in the prone position. The curved aspect of the base fits at the ankle joint supporting the foot and padding the patient from the knee to the end of the foot.

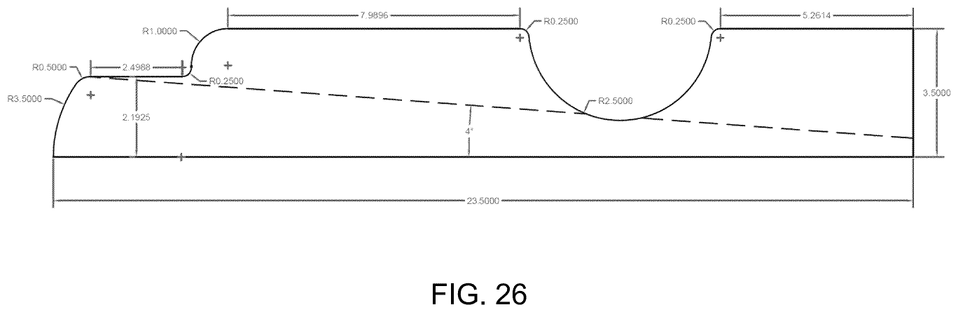

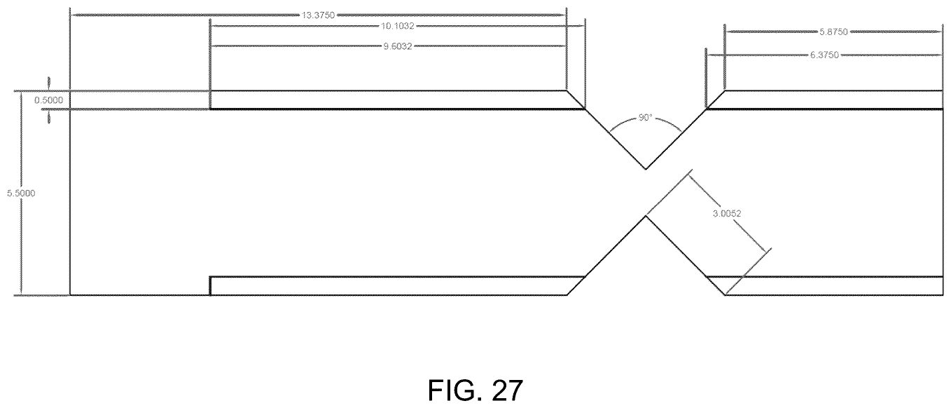

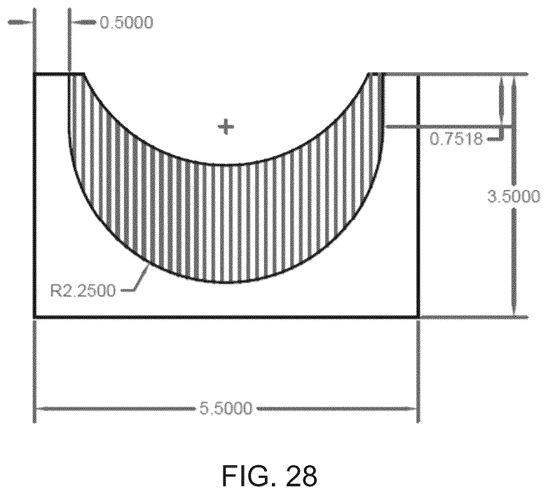

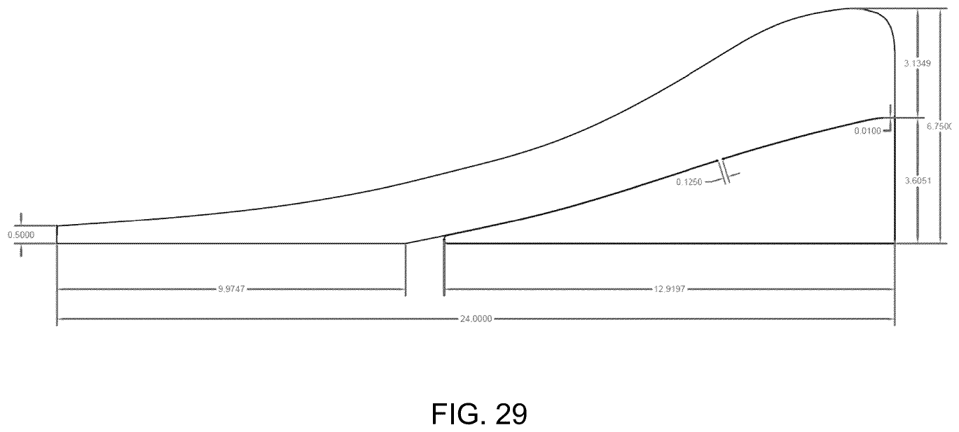

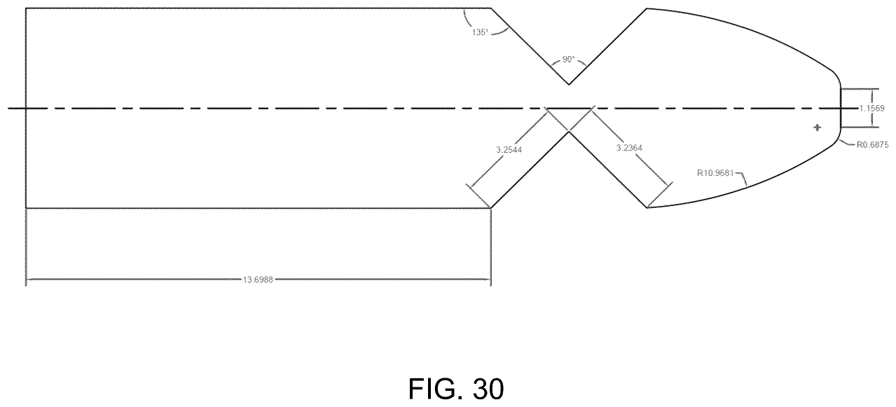

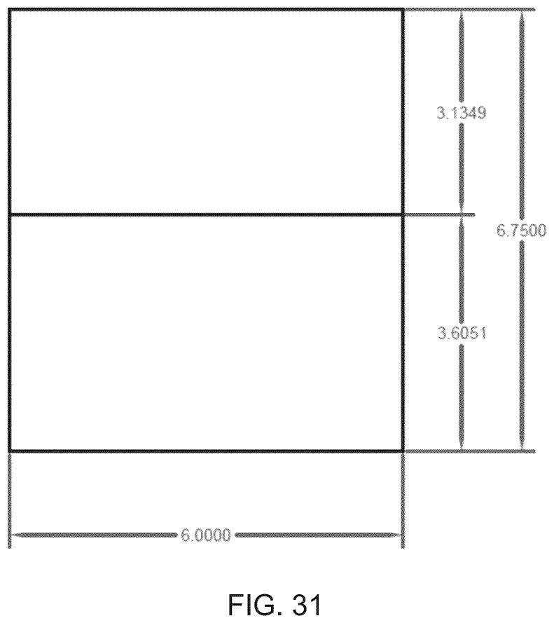

The dimensions of the limb positioning device and components thereof are not particularly limited and may be adjusted based on the age, size, medical condition, or other factors related to the patient. FIGS. 26-28 illustrate the dimensions for one embodiment of a limb cradle. FIG. 26 is a top view, FIG. 27 is a side view, and FIG. 28 is a partial front view. FIGS. 29-31 illustrate the dimensions for one embodiment of a support pad assembly. FIG. 29 is a side view, FIG. 30 is a top view, and FIG. 31 is a rear view. Ranges defined by the depicted values +/−50%, +/−25%, +/−10%, and +/−5% are expressly contemplated. For example, with respect to the length of the support pad assembly of 24 inches as depicted in FIG. 29, the ranges would be 12 to 36 inches, 18 to 30 inches, 21.6 to 26.4 inches, and 22.8 to 25.2 inches. Similar ranges defined by the +/− percentage ranges are contemplated for each individual value depicted in FIGS. 26-31. Moreover, ratios of various distances defined by the specific values and endpoints of the contemplated ranges are also contemplated.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A limb positioning device comprising:
a limb cradle comprising a first limb cradle portion, a second limb cradle portion, and a narrowed connecting strip extending between the first limb cradle portion and the second limb cradle portion to permit angulation of a limb joint; and
a support pad assembly comprising at least one support pad and configured to be placed beneath the limb cradle.

2. The limb positioning device of claim 1, wherein the support pad assembly comprises a first wedge-shaped support pad, a second wedge-shaped support pad; and a tearable support pad connection connecting the first wedge-shaped support pad to the second wedge-shaped support pad.

3. The limb positioning device of claim 1, wherein the limb cradle and the support pad assembly comprise a foam.

4. The limb positioning device of claim 1, wherein the first limb cradle portion comprises a first limb receiving channel and a first pair of limb guides; and wherein the second limb cradle portion comprises a second limb receiving channel and a second pair of limb guides.

5. The limb positioning device of claim 4, wherein the narrowed connecting strip does not comprise limb guides.

6. The limb positioning device of claim 4, wherein the second pair of limb guides do not extend to an edge of the second limb cradle portion opposite the narrowed connecting strip.

7. The limb positioning device of claim 6, wherein the edge is curved.

8. The limb positioning device of claim 1, wherein the support pad assembly comprises a narrowed portion configured to be located beneath the narrowed connecting strip of the limb cradle.

9. The limb positioning device of claim 1, wherein the first limb cradle portion is located at a higher elevation than the second limb cradle portion.

10. The limb positioning device of claim 1, wherein the limb cradle and the support pad assembly comprise a polyurethane foam.

11. The limb positioning device of claim 1, wherein the limb cradle and the support pad assembly comprise a polyethylene foam.

12. The limb positioning device of claim 1, wherein the limb cradle and the support pad assembly comprise an open-cell foam.

13. The limb positioning device of claim 1, wherein the limb cradle and the support pad assembly comprise a closed-cell foam.

14. The limb positioning device of claim 1, wherein the limb cradle comprises a foam containing an antimicrobial additive.

15. The limb positioning device of claim 14, wherein the antimicrobial comprises copper, silver, or zinc.

16. A limb positioning device comprising:
a foam limb cradle comprising:
a first limb cradle portion comprising:
a first pair of limb guides; and
a first limb receiving channel extending between the first pair of limb guides;
a second limb cradle portion comprising:
a second pair of limb guides; and
a second limb cradle portion extending between the second pair of limb guides; and
a narrowed connecting strip extending between the first limb cradle portion and the second limb cradle portion to permit angulation of a limb joint, wherein the narrowed connecting strip does not comprise limb guides; and
a support pad assembly comprising:
at least two foam support pads configured to be placed beneath the limb cradle, wherein the support pad assembly includes a narrow portion to permit angulation of the limb joint;
wherein the second pair of limb guides do not extend to an edge of the second limb cradle portion opposite the narrowed connecting strip; and
wherein the edge is curved.

17. The limb positioning device of claim 16, wherein the support pad assembly further comprises:
a tearable connecting strip connecting the two foam support pads.

18. The limb positioning device of claim 16, wherein the limb cradle and the support pad assembly comprise a polyurethane foam or a polyethylene foam.

19. The limb positioning device of claim 16, wherein the limb cradle and the support pad assembly comprise an open-cell foam.

20. The limb positioning device of claim 16, wherein the limb cradle and the support pad assembly comprise a closed-cell foam.
